(19) United States
(12) Patent Application Publication
(10) Pub. No.: US 2010/0057542 A1
(43) Pub. Date: Mar. 4, 2010

(54) WORK PROGRESS DISPLAY DEVICE AND WORK PROGRESS DISPLAY METHOD

(75) Inventors: Kazuyoshi HIRONAKA, Nagoya-shi (JP); Tomonori Sumi, Nagoya-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kimura Unity Co., LTD., Nagoya-shi (JP)

(21) Appl. No.: 12/392,566

(22) Filed: Feb. 25, 2009

(30) Foreign Application Priority Data
Aug. 26, 2008 (JP) 2008-216637

(51) Int. Cl. G06Q 10/00; G08B 23/00

(52) U.S. Cl. 705/11; 340/573.1

(57) ABSTRACT

A work progress display device and method capable of maintaining work efficiency of a worker by encouraging the worker to work. The work progress display device comprises a storage unit for storing a capability value indicating work capability of a worker, a calculation unit for calculating, in accordance with the capability value, a standard value serving as a work standard of the worker, and a display unit for displaying actual work progress of the worker as an actual performance value, and the display unit displays the standard value so as to be able to be compared with the actual performance value. By looking at this device, a worker can compare actual work progress with his or her work standard determined by his or her capability and check a difference.

The present invention is based on Japanese Patent Application No. 2008-216637, filed on Aug. 26, 2008, the entire contents of which are incorporated herein by reference.

### BACKGROUND OF THE INVENTION

1. Field of the Invention

The present invention relates to a work progress display device and method for displaying work progress of a worker.

2. Description of the Related Art

Nowadays, actual work performance of workers is grasped and collected by various methods in logistics, manufacturing, and other industries. For example, Japanese Unexamined Patent Publication No. 2007-95006 discloses an actual work performance collecting method capable of collecting, by using radio transmission, data on work a worker has performed. Japanese Unexamined Patent Publication No. 2003-104520 discloses a picking facility capable of collecting data on actual work performance of pickers.

In the respective industries, great importance is attached to thus grasping actual work performance of workers from a viewpoint of management. In each workplace, it is desired that workers constantly exhibit their capability. That is to say, it is desired that actual work performance of workers is just the same as their capability.

By the conventional methods, however, workers cannot objectively determine whether their own actual work performance is just the same as their capability or not. Even if data on actual work performance is collected, the workers cannot objectively determine whether the pace of work they are doing is slow or fast compared to their capability. That is to say, the workers cannot compare actual work progress with their work standards determined by their capability and check a difference. Accordingly, even if their pace of work is slow, the workers do not recognize it. This is a problem in view of work efficiency.

### SUMMARY OF THE INVENTION

The present invention has been made in view of the abovementioned circumstances and it is an object of the present invention to provide a work progress display device and method capable of maintaining work efficiency of a worker by encouraging the worker to work.

The work progress display device of the present invention comprises a storage unit for storing a capability value indicating work capability of a worker, a calculation unit for calculating, in accordance with the capability value, a standard value serving as a work standard of the worker, and a display unit for displaying actual work progress of the worker as an actual performance value, and the display unit displays the standard value so as to be able to be compared with the actual performance value. Owing to this construction, the worker can work, comparing the actual performance value with the standard value both displayed on the display unit. When the actual performance value is lower than the standard value, by looking at the display unit the worker can clearly grasp that the present pace of work is slower than his or her original pace of work. Accordingly, the worker is encouraged to work and work efficiency of the worker is maintained. It is noted that in the work progress display device (system), the storage unit and the display unit may be remotely located and communicate with each other by wireless transmission or the like.

The capability value used here can be the amount of work (the number of operations) scheduled to be done by the worker per predetermined period of time. In this case, the standard value is the amount of work calculated based on the capability value and elapsed time, and the actual performance value is the amount of work actually done by the worker. Thereby, the worker can more clearly compare the actual performance value with the standard value.

It is preferable that the display unit warns the worker when the actual performance value is lower than the standard value. The warning is given by, for example, display of warning on the display unit, generation of an alarm sound, and voice warning. Thereby, the worker more surely recognizes slowness of his or her pace and is encouraged to work at a faster pace.

By the way, the present invention can be described as a method for displaying work progress. That is to say, the work progress display method of the present invention comprises a storage step of storing a capability value indicating work capability of a worker, a calculation step of calculating, in accordance with the capability value, a standard value serving as a work standard of the worker, and a display step of displaying actual work performance of the worker as an actual performance value, and the display step displays the standard value so as to be able to be compared with the actual performance value. This method can exhibit a similar effect to the above.

That is to say, the work progress display device and method of the present invention enables a worker to maintain work efficiency by encouraging the worker to work.

### BRIEF DESCRIPTION OF THE DRAWINGS

FIG. 1 is a configuration diagram of a work progress display device 1 of a preferred embodiment of the present invention.

FIG. 2 is a perspective view of the work progress display device 1 and a picking cart 4.

FIG. 3 is a schematic diagram showing a display unit 33 of the work progress display device 1.

### DETAILED DESCRIPTION OF THE PREFERRED EMBODIMENT

Now, the present invention will be described in more detail by way of a preferred embodiment. It is noted that in this preferred embodiment, a work progress display device used in a picking operation is described by way of example.

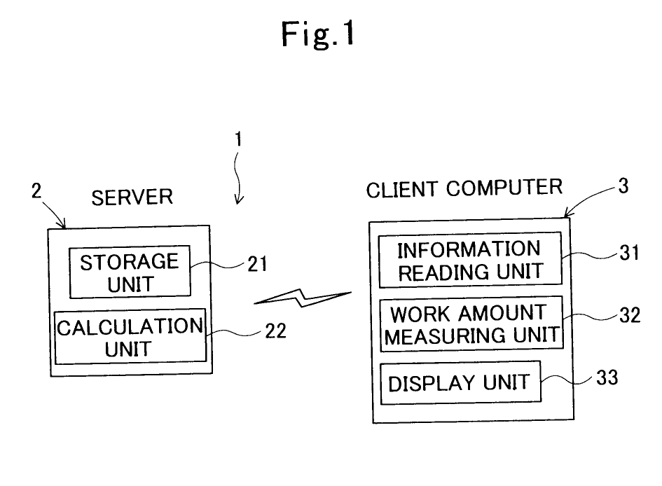

A work progress display device 1 of this preferred embodiment will be described referring to FIGS. 1 to 3.

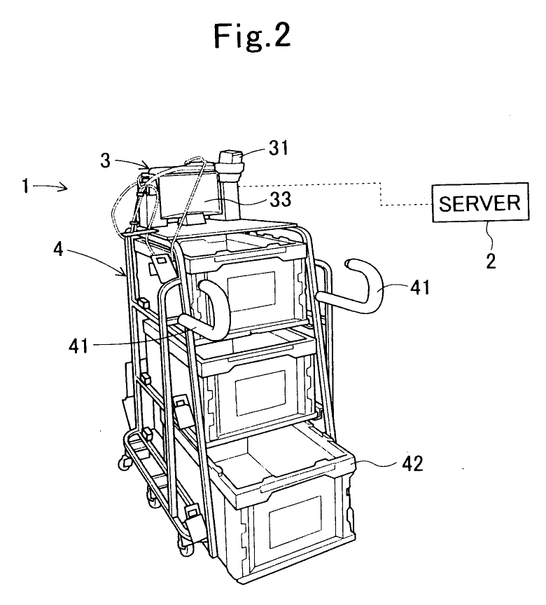

As shown in FIGS. 1 and 2, the work progress display device 1 comprises a server 2 and a client computer (herein after abbreviated as a computer) 3. The server 2 can communicate with the computer 3 by wireless transmission and is located at a distance from the computer 3. The server 2 comprises a storage unit 21 and a calculation unit 22.

The storage unit 21 stores a capability value indicating work capability of a worker on an individual basis. The capability value is preliminarily determined with respect to each worker and is stored as the amount of work to be done by the worker per predetermined period of time (the amount of work/time).

The calculation unit 22 calculates, in accordance with the capability value, a standard value serving as a work standard of the worker. The standard value is the amount of work calculated from the capability value stored in the storage unit 21 and lapsed time. That is to say, the calculation unit 22 calculates “the capability value×lapsed time=a standard value”. Here, the calculation unit 22 determines the capability value to be used in this calculation based on information (personal ID) from an information reading unit 31 which will be mentioned later. The calculation unit 22 calculates a standard value in accordance with the capability value of a worker who works actually.

The computer 3 is mounted on the picking cart 4 which is used for a picking operation and has containers 42 for storing picked articles. The computer 3 comprises the information reading unit 31, a work amount measuring unit 32, and a display unit 33. The information reading unit 31 is, for example, a scanner and can read a bar code of an article to be picked (article information) and a personal ID assigned to each worker. The information reading unit 31 is placed on the picking cart 4 and can be held and transferred by a worker.

When the read information is a personal ID, the information reading unit 31 transmits this information to the calculation unit 22. Based on the received personal ID, the calculation unit 22 determines a capability value corresponding to the personal ID from the data stored in the storage unit 21. That is to say, a worker has the information reading unit 31 read his or her own ID and has the work progress display device 1 recognize a worker who starts working. As mentioned before, the calculation unit 22 calculates a standard value in accordance with the capability value of a worker who works actually.

On the other hand, when the read information is article information, the information reading unit 31 transmits this information to the work amount measuring unit 32.

The work amount measuring unit 32 measures the amount of work by counting the number of times the work amount measuring unit 32 receives article information from the information reading unit 31. That is to say, the work amount measuring unit 32 measures the amount of work actually done by a worker. It is noted that in this case, the work amount measuring unit 32 is set to count one, every time one article is picked.

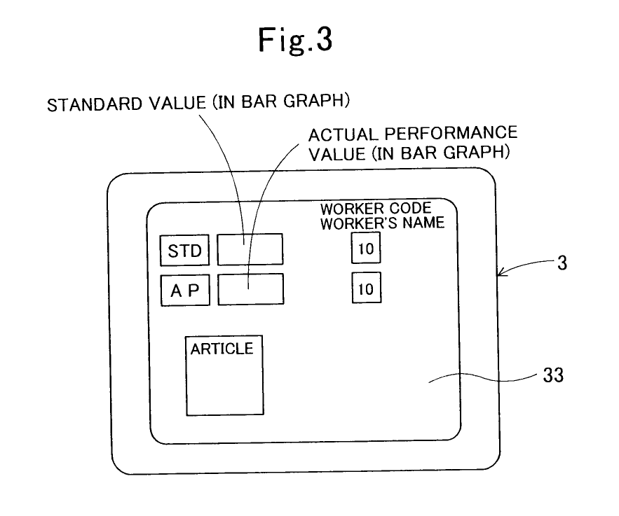

The display unit 33 faces toward handle portions 41 of the picking cart 4 so as to be seen by a worker. The display unit 33 displays the amount of work measured by the work amount measuring unit 32, that is to say, the amount of work actually done by a worker (an actual performance value). Moreover, the display unit 33 displays the amount of work received from the calculation unit 22 as a standard value. As shown in FIG. 3, the display unit 33 displays the actual performance value and the standard value in bar graphs next to each other and also displays the actual performance value and the standard value as numeric values (“10” in FIG. 3) next to each other. The display unit 33 displays the actual performance value and the standard value so that a worker can more easily compare the actual performance value with the standard value.

Moreover, the display unit 33 compares the actual performance value with the standard value. When the actual performance value is lower than the standard value, the display unit 33 informs the worker of a delay by way of a voice, for example, saying “you are delayed”. In this case, the display unit 33 may warn the worker, for example, by blinking the bar graph indicating the actual performance value. Moreover, the display unit 33 may display a warning message such as “you are delayed”. The display unit 33 also displays a worker code (a worker's ID), the worker's name, an image of an article to be picked and so on. It is noted that other displayed things (the number of articles to be picked, which container the picked article should be placed in, etc.) are omitted from FIG. 3.

As stated above, according to the work progress display device 1 of this preferred embodiment, a worker can easily and clearly grasp the present pace of work by looking at the display unit 33. When an actual performance value is lower than a standard value, the worker can objectively grasp that the present pace of work is slower than his or her original pace of work. Accordingly, the worker is encouraged to work and work efficiency of the worker is maintained.

It is noted that the work progress display device 1 can be constituted by one computer. That is to say, the work progress display device 1 comprises the storage unit 21, the calculation unit 22, the information reading unit 31 and the work amount measuring unit 32, and the display unit 33. However, when the work progress display device 1 is used for a picking cart, it is suitable in view of weight and processing load that the work progress display device 1 has a structure which is divided into the server 2 and the computer 3. With this structure, system efficiency is improved by storing picking instruction information for a worker (information on which article to be picked, the number of articles to be picked, and which container the picked article should be placed in, etc.) in the server 2 and receiving and transmitting data between the server 2 and the computer 3.

Moreover, the work amount measuring unit 32 can measure the amount of work by counting the sets of times the work amount measuring unit 32 receives article information from the information reading unit 31. The number of times an article is picked in one set can be preliminarily determined in accordance with the picking instruction information and, for example, every time five articles are picked, the work amount measuring unit 32 can count one.

Moreover, this preferred embodiment can be described as a work progress display method. That is to say, the work progress display method comprises a storage step of storing a capability value indicating work capability of a worker, a calculation step of calculating, in accordance with the capability value, a standard value serving as a work standard of the worker, and a display step of displaying actual work performance of the worker as an actual performance value, and the display step displays the standard value so as to be able to be compared with the actual performance value. This method also can exhibit a similar effect to the above.

The preferred embodiment described herein are illustrative and not restrictive, the scope of the invention being indicated by the appended claims and all variations which come within the meaning of the claims are intended to be embraced herein. The present invention may be practiced or embodied in other ways without departing from the spirit or essential character thereof and can be applied to devices other than the picking cart 4.

What is claimed is:

1. A work progress display device, comprising
a storage unit for storing a capability value indicating work capability of a worker,
a calculation unit for calculating, in accordance with the capability value, a standard value serving as a work standard of the worker, and
a display unit for displaying actual work progress of the worker as an actual performance value,
the display unit displaying the standard value so as to be able to be compared with the actual performance value.

2. The work progress display device according to claim 1, wherein
the capability value is the amount of work scheduled to be done by the worker per predetermined period of time,
the standard value is the amount of work calculated based on the capability value and lapsed time, and
the actual performance value is the amount of work actually done by the worker.

3. The work progress display device according to claim 1, wherein the display unit warns the worker when the actual performance value is lower than the standard value.

4. The work progress display device according to claim 2, wherein the display unit warns the worker when the actual performance value is lower than the standard value.

5. A work progress display method comprising:
a storage step of storing a capability value indicating work capability of a worker,
a calculation step of calculating, in accordance with the capability value, a standard value serving as a work standard of the worker, and
a display step of displaying actual work performance of the worker as an actual performance value,
the display step displaying the standard value so as to be able to be compared with the actual performance value.
